(19) United States
(12) Patent Application Publication
(10) Pub. No.: US 2005/0102843 A1
(43) Pub. Date: May 19, 2005

(54) Cutting device with spiral blades

(76) Inventor: Yuning Jiang, Woburn, MA (US)

Correspondence Address: JAMES E. MASLOW, ESQ., 4 FRANKLIN ROAD, LEXINGTON, MA, 02420, US

(21) Appl. No.: 10/715,731

(22) Filed: Nov. 17, 2003

(51) Int. Cl. B26B 13/00

(52) U.S. Cl. 30/240

(57) ABSTRACT

Cutting device for cutting objects, such as leaves, twigs, grass-like plants, fibers, hairs, and the like, having two sets of internally coupled blades, with at least one set of blades being static or dynamically formed whole spiral shape, and the blades having relative rotation therebetween for rotation, oscillation along the axes, rotational oscillation around the axes, or combinations of these motions, to create cutting actions such as shearing, sawing, or a combination of shearing and sawing, with an integrated function of mulching the cuttings generated by the cutting actions.

### FIELD OF THE INVENTION

The present invention relates to cutting devices for cutting hair, grass, twigs, and the like.

### BACKGROUND OF THE INVENTION

Broadly speaking, there are two kinds of lawn mowers, each distinguished by the type of cutting unit it has: rotary mowers and reel mowers. Rotary mowers have a single blade rotating around its axis, which is perpendicular to the ground. Reel mowers have a series of evenly spaced blades, usually three to six, mounted on a reel that rotates around its axis, which is parallel to the ground.

A comparison of these mower types is instructive. The primary advantages of rotary mowers are that they adapt to rough conditions, have a relatively low purchase price, and have easy routine maintenance (no reels to adjust or maintain). But there are some disadvantages to the rotary mowers, including being noisy, less fuel efficient, and likely to create more environmental pollution than corresponding reel mowers. They often create a scalping effect on uneven lawns and their blades can tear rather than cut lawns. Tearing damages grass and makes the grass vulnerable to various diseases. The rotary blades also present a notable risk of personal injury.

The primary advantages of the reel mowers are that they utilize efficient and scissors-like cutting action that produces the finest-quality cut, operates quietly and causes less environmental pollution, with little injury to grass. Nevertheless they have some disadvantages. For example, reel mowers cannot handle tall or thick grass, are likely to jam on the smallest twigs or stones, wiry weeds tend to fold under their blades, and they are prone to damage from hitting stones. These drawbacks make reel mowers unsuitable for utility lawn maintenance. Furthermore, reel mowers are likely to require experienced maintenance to keep blades sharp and properly adjusted.

In the last decade, with environmental awareness increasing and landfill space decreasing, mulching capability—a practical, cost-effective alternative for disposing grass clippings—has become a very appealing and even demanded feature for lawn mowers. The beneficial effects of fertilizing lawns with finely mulched grass cuttings are now widely recognized. However, mulching functionality for conventional lawn mowers has generally required additional equipment or specialized, complicated attachments.

Further, lawn fertilizers are expensive and many contain active chemicals that are not environmentally sound. It is well known that, when utilized as a fertilizer, finely cut mulch can have beneficial horticultural properties, which include reducing evaporation, maintaining constant soil temperature, preventing erosion, controlling weeds, and enriching the soil. There is therefore a need for a simple, effective and inexpensive mulcher that will recycle grass cuttings as a fertilizer for lawns and parks.

Mulching rotary mowers have been popular while reel-type mowers with mulching capability are not commonly seen. Nevertheless mulching devices for manual or power-driven reel-type lawn mowers are known. For example, U.S. Pat. No. 5,400,576 discloses a mulching device for a reel-type mowing machine, such as a power-driven mower. The mulching device is mounted to the front of a reel-type lawn mower such that the device is in closely spaced relationship to the rotating reel assembly, and above a portion of the reel assembly so as to direct a significant portion of the particles generated by the cutting action of the reel in front of the reel assembly for more complete mulching. However, the device is cumbersome and does not address mulching as a primary function of the lawn mowing activity.

U.S. Pat. No. 2,517,184 discloses a hood which is mounted over the cutting reel and which has spiral-shaped ribs located on its underside for directing cut grass back into the cutting reel to be recut for mulching. However, this patent is concerned only with manual, non-powered lawn mowers; its spiral-shaped design is also of little or no practical utility in powered mowers. The increased volume and speed of grass cuttings in power mowers would likely clog such a design, especially if the grass was wet.

Another area of interest in cutting device innovation relates to hedge trimming. Most conventional power hedge trimmers use a mechanism that converts the rotation of the motor into the oscillation of the toothed blades. This kind of converting mechanism increases the complexity of the device while reducing its efficiency and reliability. In addition, the single- or double-sided blades of conventional hedge trimmer limit maneuverability and control. When holding the trimmer for high-position or vertical trimming, the operator must maintain his or her body and wrists in awkward positions. This negatively affects the results of trimming.

A further area of interest in cutting device innovation relates to hair grooming, which also must address efficient processing and removal of cut hair while producing a comfortable and finely graded cut appearance. One problem, especially for devices with a special cutting chamber for the blades, is the need for efficient and continuous clearing of cut hair out of the cutting chamber.

An additional area of interest for cutting innovation is in the related field of grinding and mixing. Many conventional grinder-mixers work more or less as rotary mowers do, except that their blades operate at an even higher rate of speed, making these appliances among the noisiest in today's homes.

It is therefore an object of the present invention to provide a cutting device with a mulching capability, wherein the mulching is intrinsic to the design of the cutting device and is incorporated within the cutting mechanism.

It is another object of the invention to provide a cutting mechanism that provides an efficient discharge of cut material without requiring extra clearing or discharge apparatus.

It is a further object of the present invention to provide a quiet and improved cutting device with internal mulching capability.

It is a further object of the present invention to provide an improved cutting device that is adaptable to a range of cutting applications.

### SUMMARY OF THE INVENTION

Embodiments of the present invention provide innovations for use as a cutting system, as a mulching system, as a mixing system, and as a cutting system with built-in mulching and/or mixing capabilities, for a broad range of equipment incorporating rotationally and/or oscillatory interacting mechanisms. A preferred embodiment of the invention includes two sets of internally coupled rotary blades that cooperate to perform functions of the invention.

In one aspect of the invention, a lawn mower is provided with mulching functionality as an integral part of the cutting mechanism without requiring additional equipment or specialized, complicated attachments.

In another aspect of the invention, both sets of blades can be “sideless”. Their interacting spiral edges allow them to cut in any direction within 360 degrees. Therefore, a new type of power-driven hedge trimmer is provided which avoids the conventional complex mechanism for converting the rotation of the motor into the oscillation of toothed blades. The cutting action can be generated from simple rotation, no converting mechanisms of any sort is necessary. This design enhances maneuverability and control of the trimmer, whether for awkward positioned or vertical trimming.

In another aspect of the present invention, a new type of cutting unit for hair grooming is provided. In conventional vacuum-assisted hair cutters, a specialized cutting chamber is usually used and requiring rather complicated sealing mechanisms. The present invention greatly simplifies the process of creating this type of hair cutter, eliminating the need for a special cutting chamber for the blades, and therefore eliminating the need for such sealing mechanisms. The blades themselves become the cutting chamber; that is, the two sets of blades (of preferred embodiment of present invention) in cutting position inherently form a well-sealed ducting pipe through which the cut hairs are easily drawn away. The present innovation therefore improves vacuum-assisted hair cutters, where cut hair is drawn away by vacuum apparatus connected at one end of the cutting unit.

An additional aspect of the present invention provides a new type of grinding-mixing device. This new device can enhance the performance of food processors and similar appliances. Many conventional grinder-mixers work more or less as rotary mowers do, except that their blades operate at an even higher rate of speed, making these appliances among the noisiest in today's home. However, the blades of the present invention's cutting device, thanks to their effective sawing and shearing actions, do not need to spin at such a high rate of speed. Grinder-mixers using this invention are quiet as well as being very effective at grinding tough food, such as meats and fiber-rich vegetables.

Embodiments of the present invention feature two sets of internally coupled blades. The concept of “internally coupled” may be understood to have several related meanings. The first emphasizes the relative position of the two blades for cutting action. Thus, in the cutting position, the edges of the two sets of blades are always at the same side of their common tangents. In theory, these edges intersect only at points of contact, i.e., where the cutting actions are applied to objects being cut. Furthermore, when two sets of blades are at opposite sides of their common tangent, they are understood to be “externally coupled’. The second definition for the concept of internally coupled blades stresses the protective, supporting (or housing) function of one set of blades in relation to the other set. Thus, as shown in a preferred embodiment of the invention, the two sets of blades are coupled in such a way that one set of blades (the inner blades) is enclosed inside the other set (the outer blades).

In some illustrations herein only one blade is shown in each set of blades, while it will be understood that more than one blade may be included in each set. Even where only one blade is shown, at least two cutting edges can be defined on a single blade. Therefore a single blade may be considered as providing a plurality of blades (i.e., cutting edges) for purposes of this disclosure. In other examples of the invention more than one blade may be included in each set of blades. The blades in each set could be arranged in the same way as the threads of a multi-threaded screw. Hereinafter, unless explicitly stated otherwise, the abbreviated terms blade(s), inner blade(s), and outer blade(s) are used to represent a blade or a set of blades, which may be inner, outer or otherwise, having cutting edges.

Blades of the invention may be formed as coaxial spirals, such as can be seen in augers and springs. While the shape of a spring is preferred, the outer blades can be in other shapes as well, such as a partial spiral shape or a comber-like shape, among other shapes. The inner blades are usually in the shape of whole coaxial spirals, and may indeed be a single “blade” or multiple “blade segments” wound on a helix.

Further, in the context of the present invention, the concept of “spiral shape” may also be understood to have two related meanings. The first one refers only to the static geometrical properties, i.e., the dimension and the shape. The second definition emphasizes the dynamic formation of such geometrical properties. As a special case, the “dynamic” geometrical properties coincide with its corresponding “static” geometrical properties. For example, a spring is said to be in “static” spiral shape. Meanwhile a segment from one revolution of a spring that moves along a helix, of which the geometrical properties coincide with those of the spring, is said to be forming a “dynamic” spiral shape.

When driven by external power sources, the inner blade and the outer blade are able to rotate, oscillate, or rotationally oscillate independently (preferably in opposite directions). Such relative rotation, oscillation, or rotational oscillation of the blades creates cutting actions including shearing, sawing or a combination of shearing and sawing. To illustrate, a descriptive example of rotational oscillation follows: the inner blade alternately rotates, relative to the outer blade, 180 degrees clockwise and then 180 degrees counterclockwise. If one of the above two extreme positions of the inner blade corresponds to the open position of the cutting device, then the opposite extreme position will constitute the cutting position (i.e., the closed position).

The versatility of the present invention enables finding of new applications. To further demonstrate the principles at work, a description of its use as a new type of grinder-mixer follows: this grinder-mixer consists of a cutting unit according to the present invention and a container with a properly sealed cap onto which the cutting unit is mounted. Further, the cutting unit of the grinder-mixer has two main components: an auger-shaped inner blade and a spring-shaped outer blade. The two internally coupled blades are able to rotate independently of one another. The diameter of the container should be only slightly larger than that of the outer blade. In normal operation mode, the cutting unit is inserted downward into the proper amount of food that has been cut into pieces of manageable size.

If the inner blade is rotating in such direction that it causes the pieces of food to be lifted up towards the container's upper chamber, the action is like that of an auger in the transport system of a combine harvester. The pieces of food that reach the upper chamber of the container are squeezed sideward towards the outer blade. While being expelled from inner blade toward outer blade, the pieces of food will be sawed and sheared into finer pieces by both the inner blade and outer blade. The outer blade, rotating in opposite direction from the inner blade, then pushes the cut food down towards the bottom of the container. From this position, the cut food is lifted up again by the inner blade for further cutting, mixing, and grinding.

In the present invention, the quality of cut is ensured by the shearing action of the blades. Jamming problems caused by cutting long, wiry or tough objects, such as those often experienced with reel type mowers, for example, are prevented by the sawing action of the blades. Moreover, to achieve an actual sawing effect, the edges of one or both blades can be serrated. Blades with serrated edges provide additional effectiveness in tough cutting jobs (e.g., cutting twigs, rubbery objects, animal hairs, etc.), and are used to further extend the cutting action of embodiments of the present invention.

In the present invention, the spiral blades are able to move cuttings generated by cutting action in a predetermined direction and toward designated places for post-cut processing, such as mulching, mixing, or the like. This is a built-in feature, gained without any extra effort. The cuttings can also be moved by other means. For example, where one or more blowing fans are used to convey the cuttings in the same direction as the inner blade is moving them.

According to the present invention, shearing and sawing actions are combined to cut objects. Therefore, the blades do not need to spin at a high rate of speed. As a result, operation is quiet, smooth, safe, and therefore more energy-efficient and environmentally friendly.

According to the present invention, the inner blades and the outer blades are able to move independently of each other. For the sake of clarity, in most of the examples illustrated here, the movement of the outer blade is not shown. Nevertheless, the spirit of the invention should be well understood: a major aspect of the invention includes the relative motions, from which the sawing and shearing cutting actions are generated. In addition, various mechanisms, which enable two “internally coupled” parts to move independently of each other, are widely known to persons skilled in the art. A further illustration shows one of such mechanisms that enables the inner blades and the outer blades to rotate independently of each other.

According to the present invention, the outer blades, which are usually attached to the device's frame, function as a filtering shield protecting the edges of both blades. In a lawn mower this would protect the blades from hitting big stones or rocks. As for small stones or pebbles, the rotation, as the preferred form of motion, of the inner blades tends to gently spin them off instead of taking them in. One of the most important properties of spiral-shaped blades is their axial flexibility, like the elasticity of a spring. Consequently, the blades will “give in” whenever encountering objects that are harder than the blades are designed to cut. In this manner the cutting edges are protected in practice of embodiments of the invention.

Mulching or grinding capabilities are very desirable for many applications, such as lawn mowers and food processors. According to a further embodiment of the present invention, two additional sets of blades are used to mulch the clippings generated by cutting actions. One set of these additional mulching blades may be built into an end disc of the inner blade. The other set of mulching blades is built into the end plates of the frame of the invention. The inner blade, functioning as an auger, will move the clippings to the predestined side, in this case the side that has the built-in mulching blades of the cutting device, where the clippings will then be cut into finer pieces and will be expelled. Besides its capability of blowing cuttings, the blowing fan may also be used to mulch cuttings if the edges of its fan-blades are sharpened.

Like all cutting devices with shearing blades, proper adjustment of the gap between the blades is critical to the quality of cut. The present invention provides a simple gap-adjustment mechanism that fully utilizes the special property of spiral-shaped objects. It is well known that when a spiral-shaped object, such as a spring, is unwound or compressed along its axis, its radial size (internal or external diameter) will increase and otherwise if wound or extended, will decrease.

Furthermore, the shape of the spiral blades can be conical instead of cylindrical. When both blades are in conical coaxial spiral shape, the gap between them can easily be adjusted by changing their relative position along the common axis. Gap-adjustment mechanisms will be further explained later as the preferred embodiment of the present invention is discussed in detail.

Cutting long and wiry objects can be a problem for conventional cutting devices, such as reel type lawn mowers or hair clippers. Long and wiry objects tend to tangle with or fold under cutting blades and often they negatively affect the quality of cut. According to another embodiment of the present invention, a rotary comber is used to solve this problem. The comber may also be provided as self-cleaning and the cuttings or the debris will be unlikely to clog between the tines of the comber. Additional embodiments include q-shaped blades, preferably having at least one tine, a mounting ear, and a slippage stopper.

According the present invention, the cutting device can be either manual driven or power driven. Its simplicity, quietness and efficiency make it very appealing to both residential use and commercial use in various applications, such as lawn mowers, hedge trimmers, hair clipper, crop harvesters and food processors, among others.

These and other advantages, features and benefits of the invention are set forth herein.

### BRIEF DESCRIPTION OF THE DRAWINGS

The present invention will be described more in detail below with reference to the enclosed drawings, which show illustrative and preferred embodiments of the invention, without being limited hereto. In the drawings, reference characters or numbers generally refer to the same parts throughout the different views. Further, the drawings are not necessarily to scale, emphasis instead generally being placed upon illustrating the principles and spirit of the present invention. In the drawings:

FIG. 1A is a partly cutaway front view of a cutting device according to a preferred embodiment of the present invention, with reference to the moving direction of the cutting device relative to the objects being cut when in normal operation.

FIG. 1B is a rear view of the cutting device of FIG. 1A.

FIG. 1C is a cross section taken through line C-C of FIG. 1B, showing congruency of the cutting blades, without showing the blowing fans for sake of clarity.

FIG. 2A is a left side view of the cutting device of FIG. 1A.

FIG. 2B is a right side view of the cutting device of FIG. 1A.

FIG. 3A is a partly cut away front view of the inner blade subassembly of FIG. 1A.

FIG. 3B is a face view of the right end disc of an inner blade of FIG. 1A.

FIG. 4A is a partly cut away front view of an outer blade subassembly of FIG. 1A, including end-rings.

FIG. 4B is a right side view of the outer blade subassembly of FIG. 4A, showing a face view of an end-ring as well.

FIG. 5 is a front view of the frame subassembly of FIG. 1A.

FIG. 6 is a top view of an outer blade subassembly, illustrating another embodiment of the outer blades, of which the shape resembles that of a comber.

FIG. 6A shows the cross sectional view of the outer blade along the line D-D of FIG. 6.

FIG. 6B is an enlarged cross sectional view of the outer blade along line E-E of FIG. 6A, showing the cutting edges as well.

FIG. 6C is a right side view of the outer blade subassembly of FIG. 6, showing the end-ring and the comber tine as well.

FIG. 7 is a front view of a q-shaped unit, which alone forms an outer blade.

FIG. 7A is a right side view of the q-shaped unit of FIG. 7, showing cutting blade, mounting ears, comber tine and slippage-stopper.

FIG. 7B is a cross sectional view of the q-shaped unit along line M-M of FIG. 7A.

FIG. 8 is a partly cut away top view of an outer blade subassembly in another embodiment, which is composed of a series of q-shaped units of FIG. 7.

FIG. 8A is a right side view of the outer blade subassembly of FIG. 8.

FIG. 9 is a partly cut away top view of an outer blade subassembly showing another embodiment of the outer blade, which is a “hybrid” of the comber shape of FIG. 6 and the spring shape of FIG. 4A.

FIG. 9A is a right side view of the “hybrid” outer blade subassembly of FIG. 9, showing the end-ring as well.

FIG. 10 a front view of an inner blade subassembly illustrating an embodiment of the inner blade, which is in the shape of a “double threaded” auger.

FIG. 11 is a face view of the end disc of the inner blade subassembly of FIG. 10.

FIG. 12 is a front view of an inner blade subassembly, illustrating a means to dynamically form spiral-shaped blades via a series of “simple and straight” blades.

FIG. 13 is the cross sectional view of the “dynamic” inner blade subassembly along line F-F of FIG. 12.

FIG. 14 is a front view of another embodiment of dynamically formed inner blade, which is composed of a series of fan units.

FIG. 15 is a face view of the fan unit, which is composed of a hub and three blade units. Each blade unit includes a spoke and a cutting tip.

FIG. 16 is a left side view of the fan unit of FIG. 15.

FIG. 17 is a right side view of the fan unit of FIG. 15.

FIG. 18 shows a face view of a blowing fan used in an embodiment of the present invention.

FIG. 19 is a left side view of the blowing fan of FIG. 18.

FIG. 20 to FIG. 25 illustrate different geometrical cross sections of the blades, in several embodiments of the present invention.

FIG. 26 is a top view of an alternative embodiment of the present invention, showing a rotary comber.

FIG. 27 is a left side view of the device of FIG. 26.

FIG. 28 is a top view of the rotary comber embodiment of FIG. 26.

FIG. 29 is a left side view of the rotary comber of FIG. 28.

FIG. 30 is a top view of an alternative embodiment of the rotary comber of present invention.

FIG. 31 is a left side view of the rotary comber of FIG. 30.

FIG. 32 shows a side view of a cutting device with internally coupled blades according to an illustrative embodiment of the invention.

FIG. 33 is a front view of the device in FIG. 32 with the right hand half showing a cross sectional view along line G-G of FIG. 32.

FIG. 34 is a cross-sectional view of the device along line H-H of FIG. 33.

FIG. 35 shows a side view of a cutting unit, which simulates the cutting unit of reel type lawn mowers.

FIG. 36 is a partly cut away front view of the embodiment of FIG. 35.

FIG. 37 is a cross sectional view along line J-J of FIG. 36.

FIG. 38 shows a cross sectional view along line K-K of FIG. 36.

FIG. 39 is a cross sectional view along line L-L of FIG. 38.

FIG. 40 is a face view of a cutting device simulating the cutting unit of rotary-blade lawn mowers, with a partly cut away view of a bevel-gear transmission.

FIG. 41 shows the bottom view of the cutting device of FIG. 40.

### DESCRIPTION OF PREFERRED EMBODIMENT

The present invention provides method and apparatus for a new cutting device that has advantages for a wide variety of applications. Uses include a cutting unit for lawn mowers, for hedge trimmers, for hair cutters, and for grinding-mixing devices, among other uses.

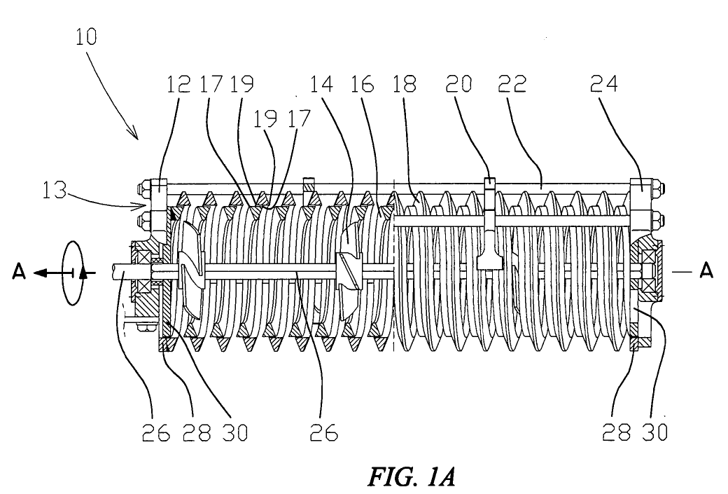

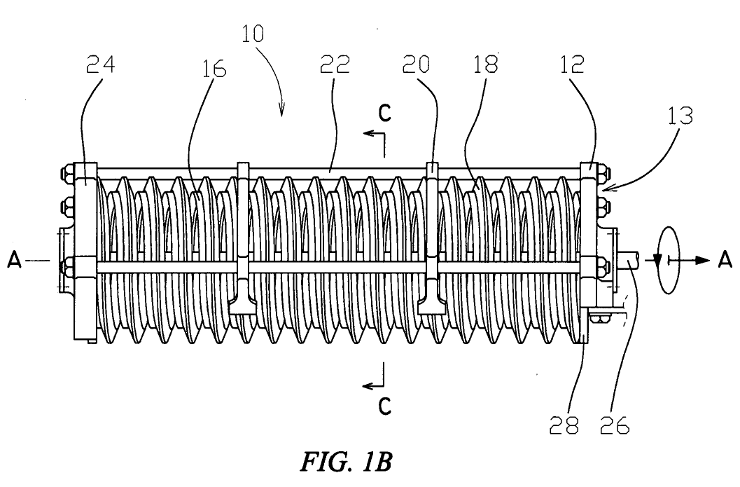

Referring now to FIG. 1-5, an illustrative embodiment of the present invention forms a cutting device 10, featuring two spring-shaped (or spiral-shaped) blades. The first blade is an inner blade 16 and the second blade is an outer blade 18. These internally coupled blades are featured components of preferred embodiments of the invention. FIG. 1A shows the cutting device 10 in front view, and FIG. 1B is a rear view, with reference to the moving direction of the cutting device relative to the objects to be cut when in normal operation. The inner blade 16 is able to rotate or rotationally oscillate about its axis A.

The internally coupled interaction between the inner blade 16 and the outer blade 18 may be further characterized as connoting the geometric relationship of being internally tangent, wherein two circles define the edges of the blades and are described as one inside the other with both intersecting at one point of tangency. In practice of present invention, the gap between the cutting blades is precisely established and maintained. However, a meaningful point of tangency is defined where the cutting actions are being applied to the objects being cut. There might be more than one point of tangency at one time during normal operation. One instance of the internal point of tangency T is indicated in the cross-sectional view of cutting device 10 shown in FIG. 1C.

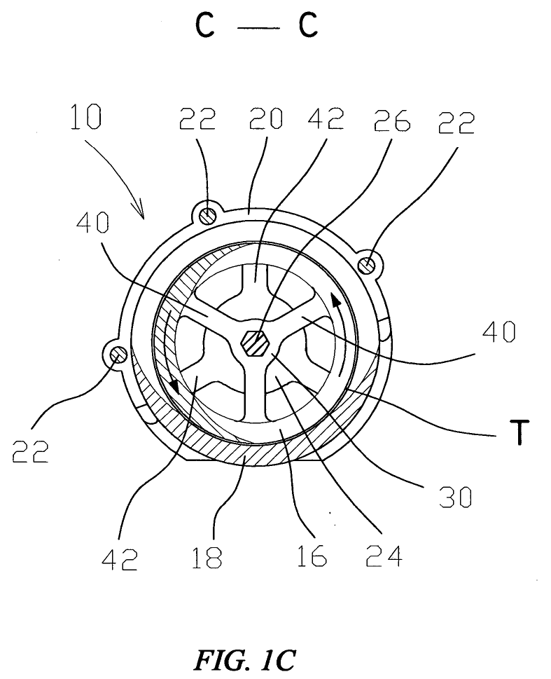

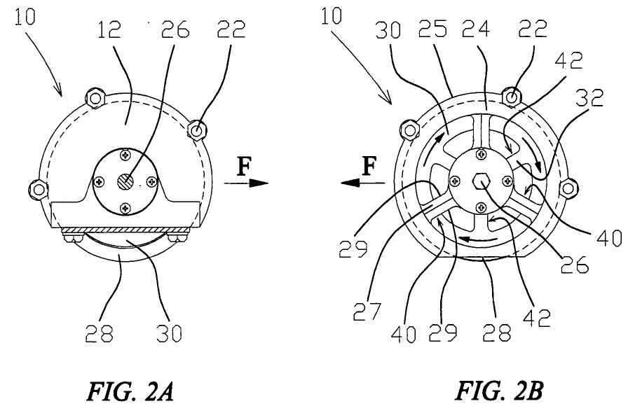

The invention further includes a frame subassembly 13, having left end plate 12, right end plate 24, horseshoe shaped retainers 20 and linking bars 22. A left side view and a right side view of the frame assembly are also shown in FIGS. 2A and 2B respectively. Right end plate 24 has an outer rim 25 and connecting spokes 27 emanating from a hub that captures one end of driven shaft 26. Meanwhile left end plate 12 may have spokes or may be solid, and in any event provides a bearing block for support of driven shaft 26 and provides for anchoring of linking bars 22, as well as capture of one end-ring 28, which is affixed to each end of outer blade 18.

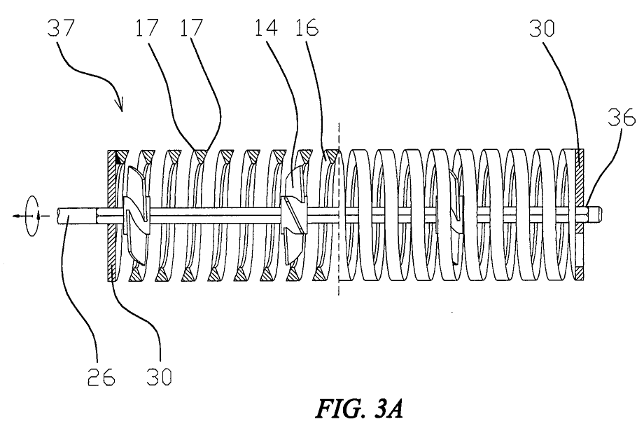

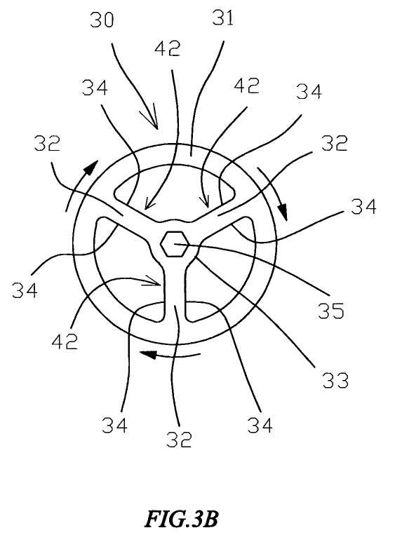

FIG. 3A is a front view of an inner blade subassembly 37, which includes the inner blade 16, end discs 30, driven shaft 26 and cuttings blowing fans 14. The end disc 30 is shown in detail in FIG. 3B having an outer rim 31 and connecting spokes 32 emanating from hub 33. The inner blade 16 is formed with end discs 30 attached. These end discs have through-holes at their centers, e.g., hexagonal hole 35. The end discs are mounted over shaft 26, which has matching hexagonal cross-section 36. Thus rotation of driven shaft 26 rotates end discs 30 and the attached blade 16. This rotation may be continuous, discontinuous or oscillatory.

As seen in FIG. 2B, 3B, mulching blade 42 consists of spoke 32 with cutting edges 34. Mulching blades 42 rotate along with the rotating inner blade 16. Likewise, mulching blade 40 is composed of spoke 27 with cutting edges 29. Mulching blades 40 cooperate with mulching blades 42, in a mulching function of the invention, to mulch the internally captured cuttings generated by the cutting action of inner blade 16 cooperating, in relative rotation, with the outer blades 18.

FIG. 4A-4B shows outer blade subassembly 38, having outer blade 18 with end-rings 28 affixed at each end. Outer blade subassembly 38 is captured between end plate 12 and end plate 24 of the frame subassembly 13 at end-rings 28. The outer blade and frame components cooperate to present a stable rotary cutting environment relative to the cutting axis A. The cutting action is achieved by cooperation of the outer cutting edges 17 of the rotating inner blade 16 and the inner cutting edges 19 of the outer blade 18.

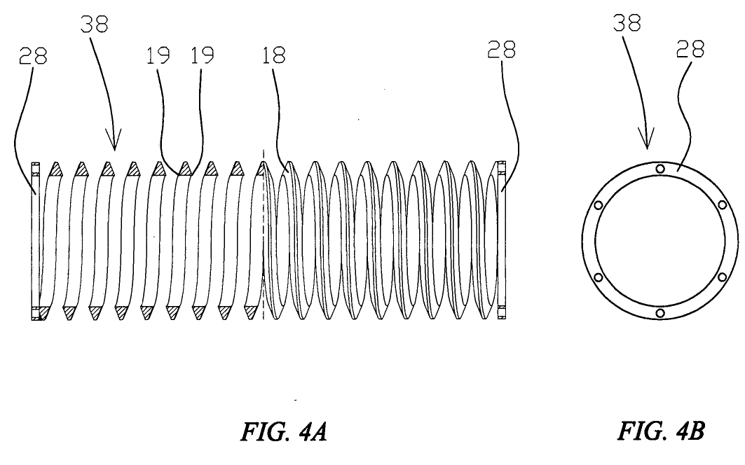

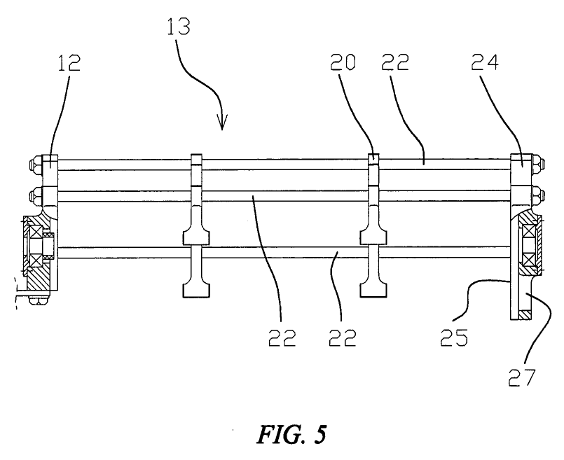

FIG. 5 shows the details of the frame sub-assembly 13. The horseshoe shaped retainer 20, mounted on the linking bars 22, is used to stabilize the outer blade. The result is to stiffen the assembly and to reduce or eliminate unwanted radial oscillation of both inner blade 16 and outer blade 18.

Besides simply rotating on its axis, if the embodiment calls for such ability, the inner blade can rotationally oscillate about it axis. In some applications, the rotational oscillation generates a better cutting effect than simple rotation does. Also rotational oscillation, which is intermittent or non-continuous, will add impact force to cutting action. Impact effect is desirable for certain applications. For an example, if the objects are made of tough materials, say rubber or plastics, a series of intermittent, but progressive cuts may be needed in order to cut off the object completely. These progressive cuts can be provided and amplified by this rotational oscillation.

Furthermore, in a preferred embodiment, which is driven by external power sources (not shown), the inner blade and the outer blade are able to apparently rotate, oscillate, or rotationally oscillate independently of each other (preferably in opposite directions). Such rotation, oscillation, or rotational oscillation of the blades creates cutting actions including shearing, sawing or a combination of shearing and sawing. Such rotation may be actual or apparent (i.e., relative), wherein one of the blades may be stationary.

Rotational oscillation in practice of the invention proceeds wherein the inner blade alternately rotates, relative to the outer blade, preferably 180 degrees clockwise and then 180 degrees counterclockwise. If one of the above two extreme positions of the inner blade corresponds to the open position of the cutting device, then the opposite extreme position will constitute the cutting position (i.e., the closed position).

To adjust the gap between the inner blade 16 and the outer blade 18, one could simply wind or unwind the inner blade 16 via twisting the end discs 30 accordingly before mounting the inner blade 16 onto the driven shaft 26. After the inner blade 16 is mounted onto the driven shaft 26, both of the end discs 30 will be locked in their proper positions and thus the gap between the two blades is retained.

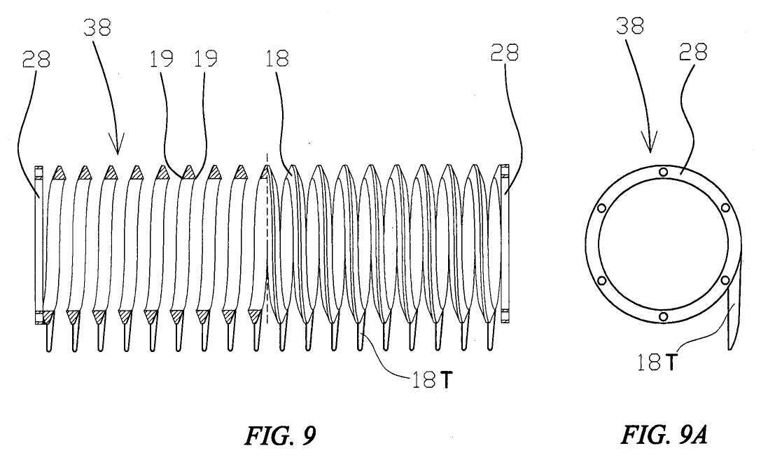

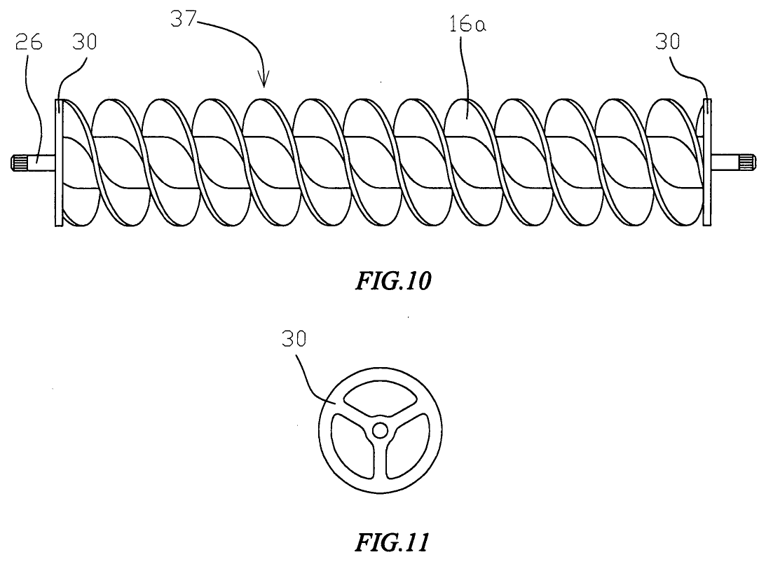

With the hexagonal hole 35 of the end plate 30 of the inner blade subassembly and the hexagonal cross-section 36 of the driven shaft 26, the end plates 30 can only be twisted and then locked at an angle of multiples of 60 degrees (360 divided by 6). It can be easily appreciated that if the shape of the cross-section of the driven shaft, thus that of the holes of the end plates accordingly, is changed from hexagon to other polygon with more sides (say octagon) or even to a “toothed wheel” shape, the overall precision of gap adjustment will increase significantly. It is also desirable to pre-wind the inner blade so that it can later be unwound to compensate the increase in the gap between the two blades due to normal wearing. By the same token, pre-unwinding the outer blade can achieve the same effect of adjusting the gap. In some cases, such as when the inner blade 16 is in the shape of an auger 16a (see FIG. 10), pre-unwinding the outer blade 18 might be the preferred means for gap adjustment.

Another means of adjusting and maintaining the gap between the inner blade 16 and the outer blade 18 at or near their points of tangency is to control the directional distance between their geometrical or rotary axes. It can be easily understood that when the diameter of inner blade is substantially smaller than that of the outer blade, the two circles of the blades have to be eccentric in order to maintain their points of tangency. In this case, the gap between the two blades can also be adjusted and maintained by controlling the eccentricity of the two circles of the blades.

Mulching or grinding capabilities are very desirable for many applications, such as lawn mowers and food processors. According to a preferred embodiment (see FIG. 1A) of the present invention, two additional sets of blades 40, 42 are used to mulch the clippings generated by cutting action of blades 16, 18. Preferred mulching blades 42 are built into the right end disc 30 of the inner blade 16 and mulching blades 40 are built into the right end plate 24 associated with the frame subassembly 13.

The inner blade 16, functioning as an auger, will move the clippings to the predestined side, in this case the right side (see FIG. 1A), of the cutting device, where they will then be cut into finer pieces by mulching blades 40 and 42. This is noteworthy, since prior art lawn mowers either do not have mulching capability or have a more complicated mechanism for their mulching capability. Within the present invention, mulching capability becomes a naturally integrated function.

Many transportation systems utilize spiral surfaces to transport objects. For example, augers are widely used in combine harvesters to collect cut crops from the field. They are also used in snow throwers to remove snows from the walkways. According to the present invention, the inner blade, working like the auger in these transport systems, moves the clippings captured inside the blades along the spiral direction. In addition, the blowing fans 14 (see FIG. 1A) are arranged in such a way that they work together with the inner blade 16 to propel clippings in the same exhaust direction.

While the spring or whole spiral shape is preferred, the outer blade can be in other shapes as well. FIG. 6-6C show a comber shaped outer blade with multiple tines 18T. The tines 18T are used to erect objects being cut (such grass blades) and guide them into spaces of the blades for higher quality of cut.

More particularly, FIG. 6 illustrates another embodiment of the outer blades 18, which is in the shape of a comber wherein FIG. 6A shows the cross sectional view of the outer blade 18 along the line D-D of FIG. 6 and FIG. 6B is an enlarged cross sectional view of the comber shaped outer blade 18 along line E-E of FIG. 6A and showing the cutting edges 19 of the outer blade.

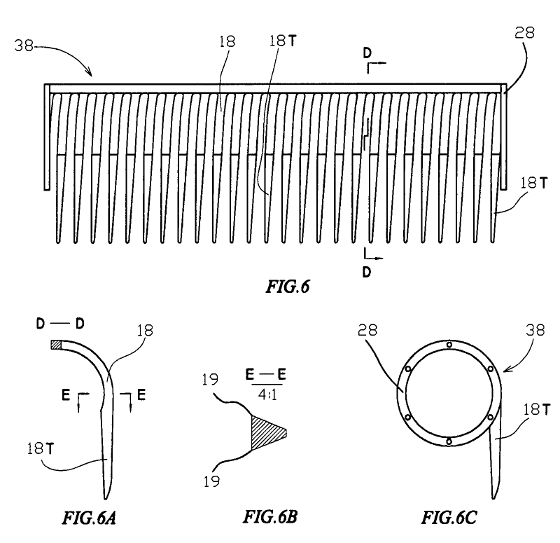

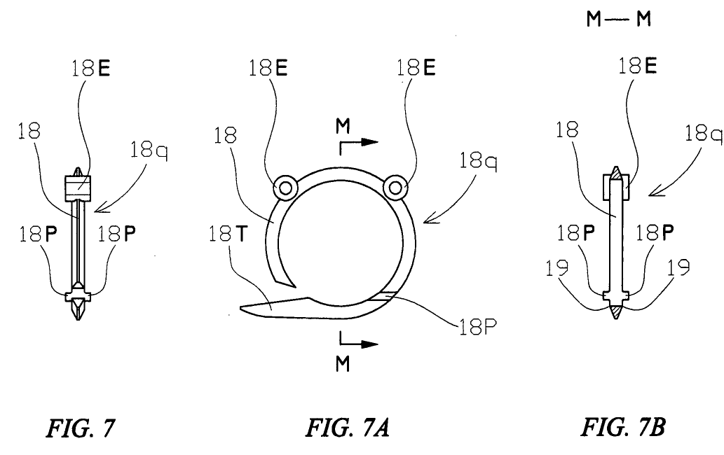

Broadly speaking, a circle is a helix (spiral) with pitch equal to 0 and height to 1. FIG. 7-7B illustrate a q-shaped unit 18q, which is composed of circular outer blade 18, tine 18T, mounting ear 18E, and slippage-stopper 18P. In this case, the cutting edges 19 are in two-dimensional circle instead of three-dimensional spiral. The q-shaped unit 18q alone forms an outer blade.

Slippage of objects being cut along cutting edges is a very common issue, especially when cutting tough and big objects. For example, big twigs tend to slip out of the cutting edges of a trimmer. Serrated cutting edges help prevent such slippage, but for cutting bigger or tougher objects, slippage-stopper 18P or similar mechanisms become necessary. Slippage-stopper 18P will stop the objects being cut from slipping out of the cutting device while the inner blades are applying shearing and sawing actions against the objects. It can be easily understood that the slippage-stopper can, in fact, be any means that block the exiting paths of the objects being cut. It can also be easily appreciated that the slippage-stoppers may be built onto the inner blades as well, since the motions between the inner blades and the outer blades are really relative.

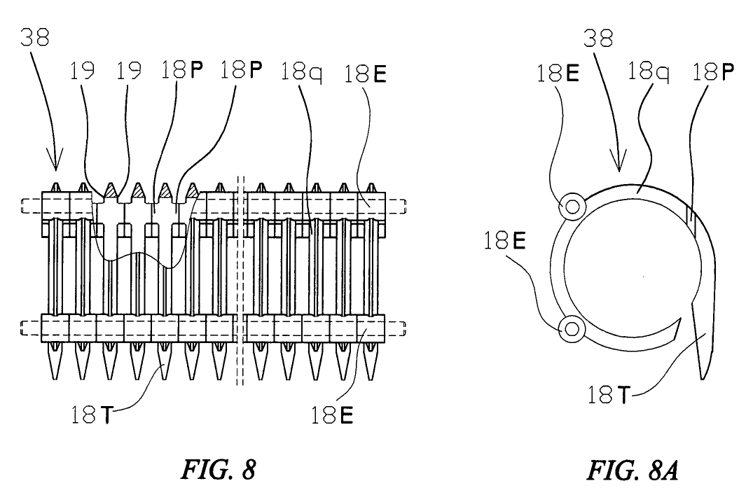

FIG. 8-8A illustrate an outer blade subassembly 38 created by linking together a series of q-shaped units 18q, which alone can be thought as one outer blade. The mounting ears 18E have a mounting hole for coupling with the linking bars (shown in dashed lines). This eliminates the necessity of horseshoe shaped retainer 20 as shown in FIG. 1A-1C.

FIG. 9-9A illustrate an outer blade in a more complex shape, which is a “hybrid” of a comber and a spring. In particular, this is a hybrid of the comber shape of FIG. 6 and the spring shape of FIG. 4A. The “hybrid” outer blade can be described as though the tines T18 are evenly spaced and affixed to a spring shaped outer blade. FIG. 9A is a right side view of the outer blade subassembly of FIG. 9.

Shown in FIG. 10 is an inner blade subassembly 37 featuring a “double threaded” auger-shaped inner blade 16a, illustrating another embodiment of the present invent. FIG. 11 shows the end disc 30 of the inner blade subassembly 37 of FIG. 10. In this case, the hole in the center of the end disc 30 is a circle instead of a hexagon.

According to the present invention, the inner blade can either be in “static” spiral shapes, such as that illustrated in FIG. 3A and FIG. 10, or in “dynamic” spiral shape. Illustrated in FIG. 12-13 is an example of “dynamic” spiral-shaped inner blades, which are “statically” composed of a driven shaft 26 and one or more “simple and straight” blades 16S that are affixed to the driven shaft. The straight blades 16S are evenly spaced along the driven shaft 26 such that when the driven shaft is simultaneously rotating about its axis and oscillating along its axis, the straight blades will dynamically form a set of spiral cutting blades.

FIG. 12 shows the dynamically formed inner blade 16 with driven shaft 26 simultaneously rotating about its axis A and oscillating along its axis A with a range of R. FIG. 13 shows the “dynamic” inner blade subassembly along line F-F of FIG. 12, showing the direction of the rotation of a “simple and straight” blade 16S, as an illustrative embodiment.

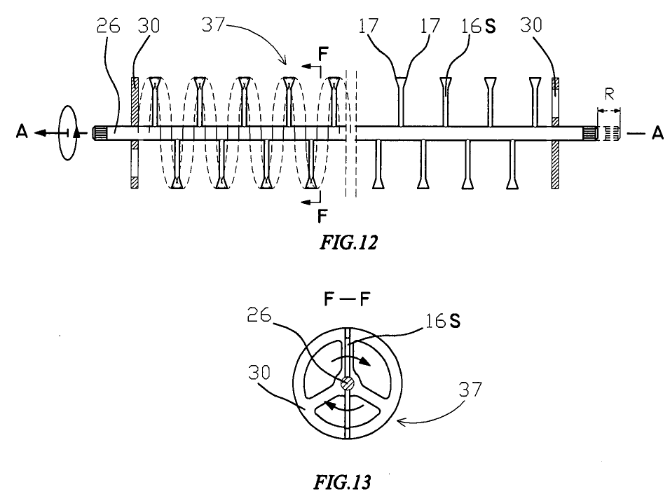

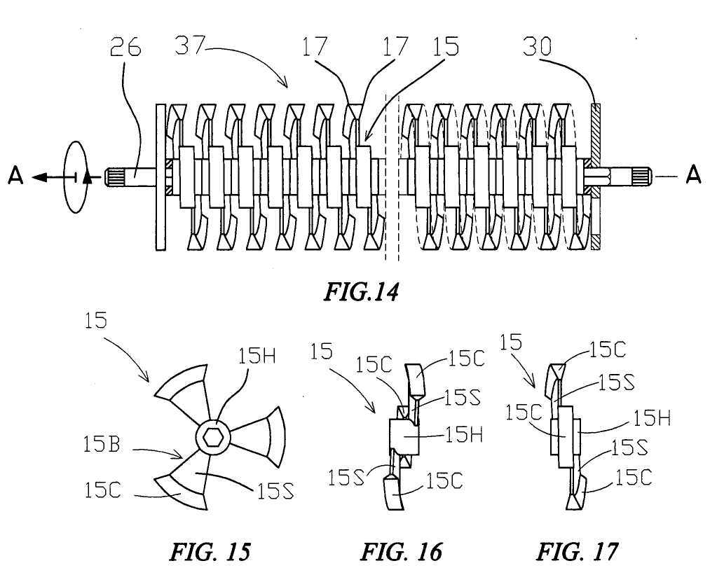

Another way of forming a “dynamic” spiral-shape blade is to “wind” an array of spiral segments of the corresponding “static” spiral-shaped blade along a helix that coincides with the geometrical properties of the corresponding “static” spiral-shaped blade. Demonstrated in FIG. 14-17 is an example of such formation of the “dynamic” spiral-shaped inner blades.

More particularly, in an embodiment of the illustration of FIG. 14-17, the “spiral blade” may include a series of fan units 15 that are in the shape of a fan and function as cuttings blowing fans as well. Each of those fan units is composed of a hub 15H and three blade units 15B that emanate from the hub. Each of those blade units 15B is composed of a spoke 15S and a cutting tip 15C, which is affixed to the outer rim of the spoke. Each cutting tip 15C can be considered as a segment taken from the corresponding “static” spiral blade, which has the cutting edges 17. The three blade units 15B are evenly spaced around the hub 15H in such a way that the three cutting tips will dynamically imitate one revolution (as shown in “dashed lines” of FIG. 14) of the corresponding “static” spiral blade. When driven by the driven shaft 26 that is rotating around its axis, all the cutting tips 15C combined will have a similar cutting effect as the corresponding “static” spiral blade. It also can be easily appreciated that if the number of blade units 15B (therefore the number of cutting tips 15C) within one revolution increases, say from three to six, the shape of the resulted “dynamic spiral blade” will more closely resemble that of the corresponding “static” spiral blade.

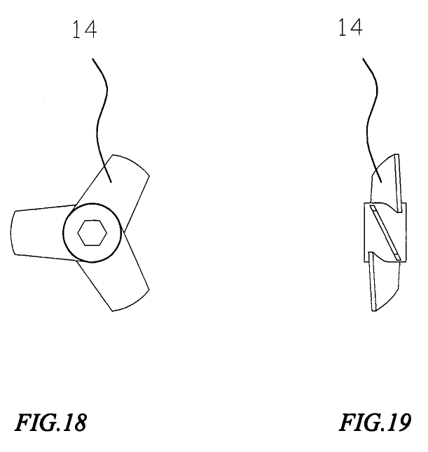

FIG. 18 and FIG. 19 show a blowing fan, illustrating a possible means to move the cuttings generated by the cutting actions of the blades in an embodiment of the present invention.

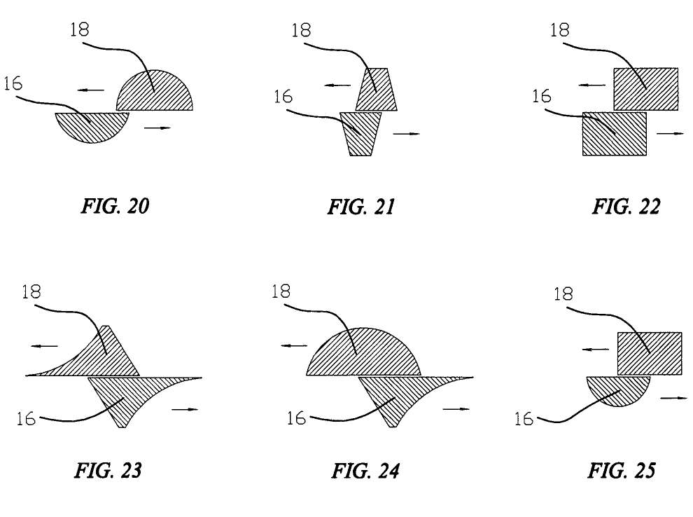

With respect to FIG. 20-25, there are illustrated several geometric cross sections of the inner blade 16 and the outer blade 18. While simple geometric cross sections, such as partial circles, triangles with curved sides, trapezoids, and rectangles, are shown here, a combination of these simple shapes may be used to serve different purposes. When combined, for example, the inner blade 16 of triangle with curved sides and the outer blade 18 of partial circle may be very desirable to create a new type of cutting unit for hair clippers (see FIG. 24). For example, since the outer blade of partial circle is safe and comfortable to the human skin while sharp edges of the inner blade of triangle with curved sides will create a clean and efficient cut, especially when the edges are serrated.

Cutting long and wiry objects can be a problem for conventional cutting devices, such as reel type lawn mowers or hair clippers. Long and wiry objects tend to tangle with or fold under cutting blades and often they negatively affect the quality of cut. According to the present invention, the spaces between revolutions of spiral blades extend in such a way that they allow objects to be cut to be easily fed into the cutting device. For example, when the cutting device is used in lawn mowers, the spaces will extend substantially vertical to the ground, or in the same direction as the grass blades stand and grow. In addition, rotary combers can be used to solve this problem by erecting and raking in the objects to be cut.

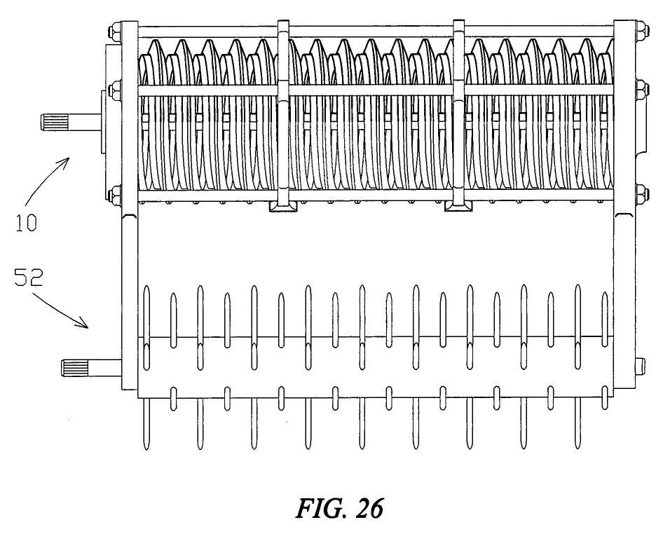

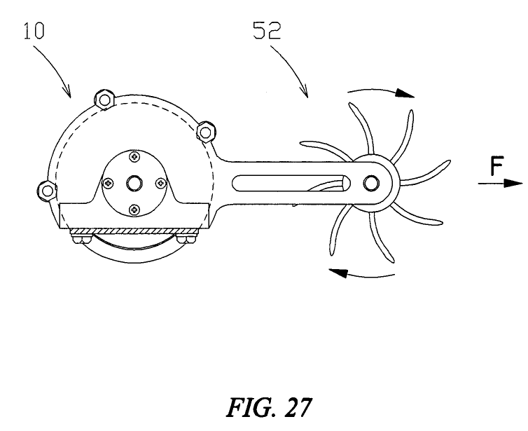

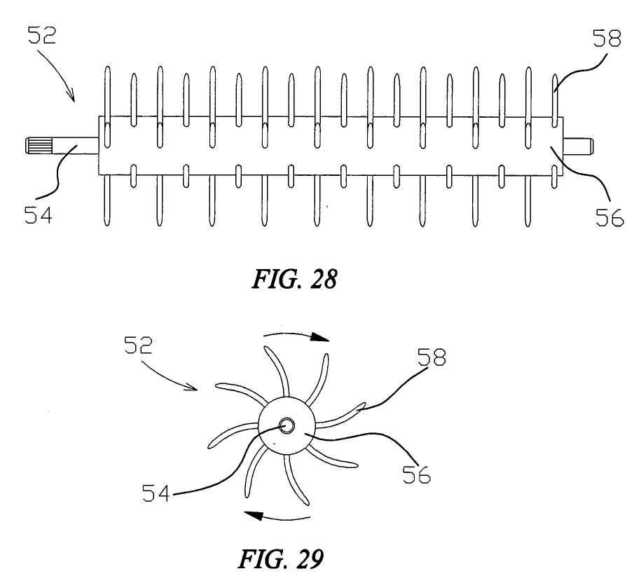

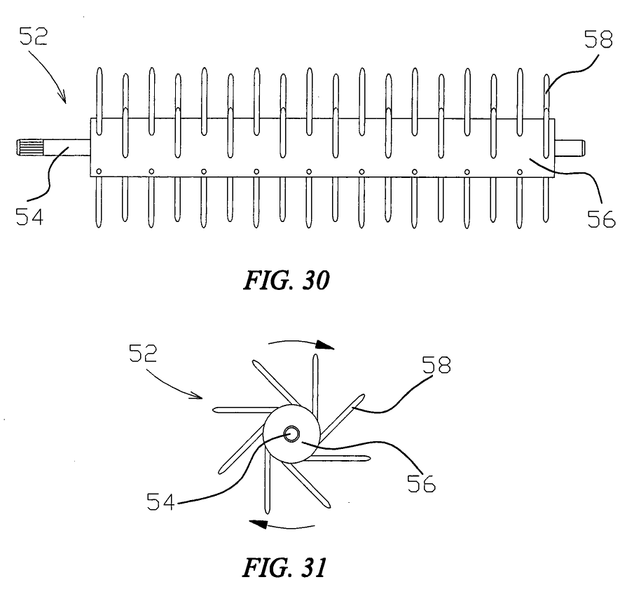

In one embodiment of the invention, a rotary comber 52 as shown in FIG. 26-31 is used to improve cutting in practice of the invention in the above circumstances. The rotary comber 52 is comprised of a driven shaft 54, a rotating drum 56 and a number of tines 58, which are evenly spaced along the surface of the rotating drum 56. Driven by the driven shaft 54, the rotary comber 52 rotates (in clockwise direction as shown in FIG. 29 and FIG. 31) in the opposite direction in which the tines 58 are fanned out (in counterclockwise direction as shown in FIG. 29 and FIG. 31). The tines 58 are designed and arranged in such a way that they are self-cleaning and the debris are therefore unlikely to clog between the tines of the comber. The cutting device 10 of present invention is combined with the rotary comber 52 as shown in FIG. 26 and FIG. 27, such that in operation, the rotary comber 52 erects and rakes in the objects that are to be cut by the cutting device 10.

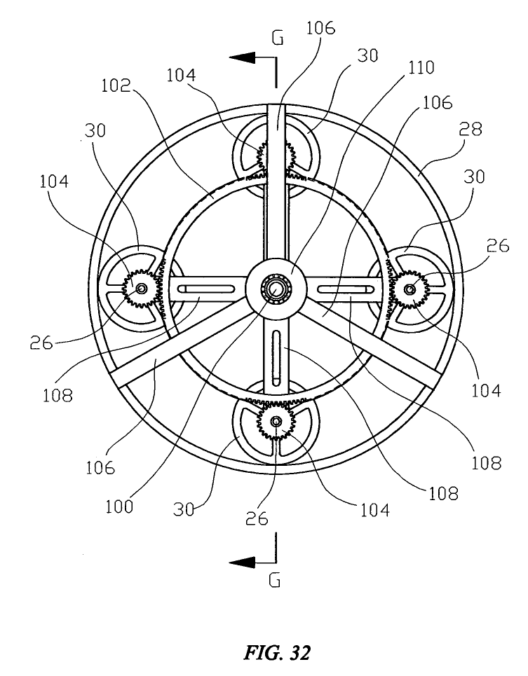

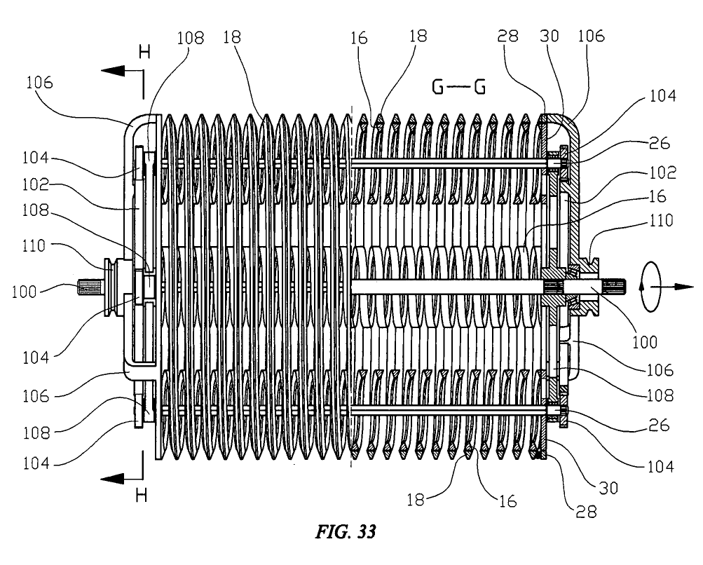

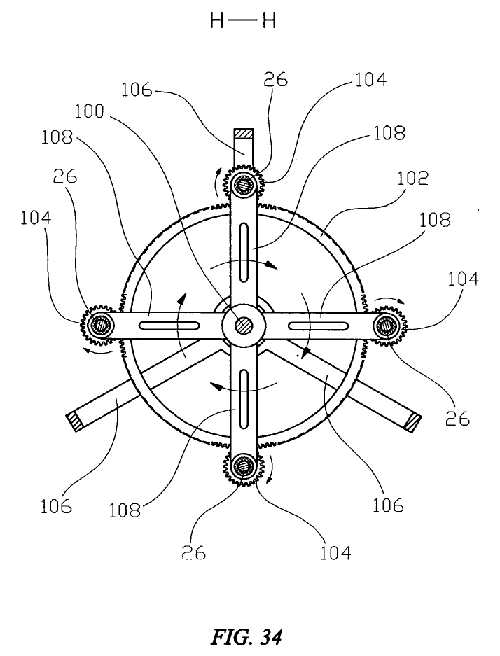

Many new cutting devices can be derived from the present invention by using simple combinations or different configurations. FIG. 32 to FIG. 34 illustrate the concept of “internally coupled” with a set of four inner blades internally coupled with one outer blade. More specifically, a cutting device illustrated here is mainly composed of one epicyclic gear train, one outer blade 18 and one blade subassembly that includes four inner blades 16 that are internally coupled with the outer blade 18. In normal operation, the central driven shaft 100 rotates the four planet-carriers 108, which then will “carry” the planet gears 104. The planet gears 104 meshing with the external central gear 102 will rotate the driven shafts 26, which in turn will rotate the inner blades 16. The outer blade subassembly consists of an outer blade 18, two end-rings 28 and two central gear subassemblies, each of which is composed of one external central gear 102, three spokes 106 emanating from the drive-pulley 110 that captures one end of central driven shaft 100. Driven by external power sources, the drive-pulley 110 that is affixed the end-ring 28 of the outer blade 18 via the spokes 106 and the central driven shaft 100 that is affixed to the four planet-carriers are able to rotate about their axis independently. Therefore the four inner blades 16 and the outer blade 18 are able to rotate independent of each other.

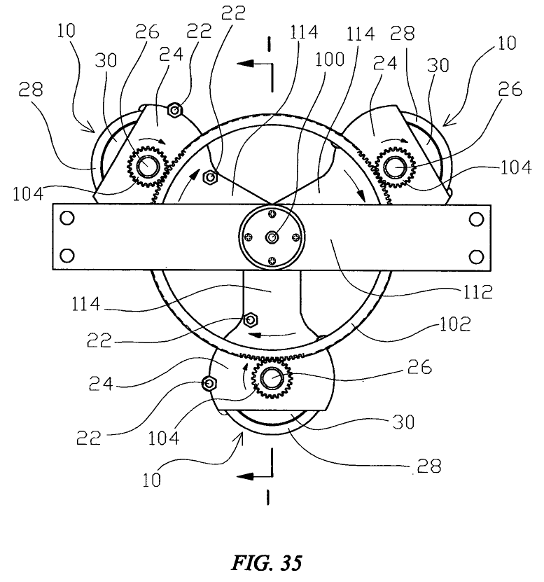

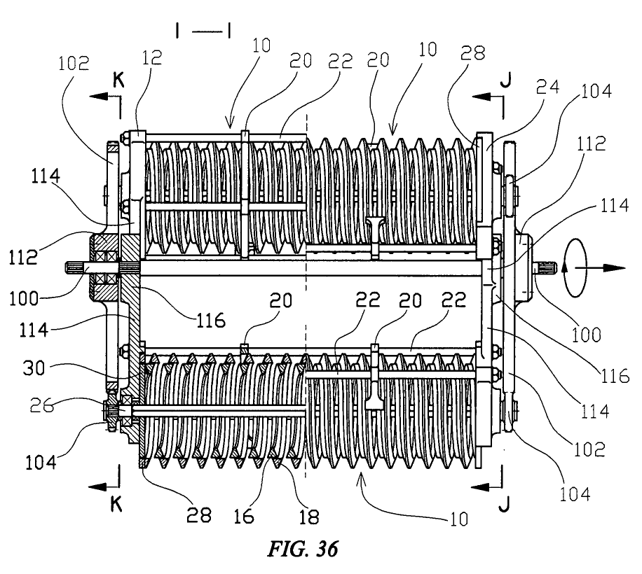

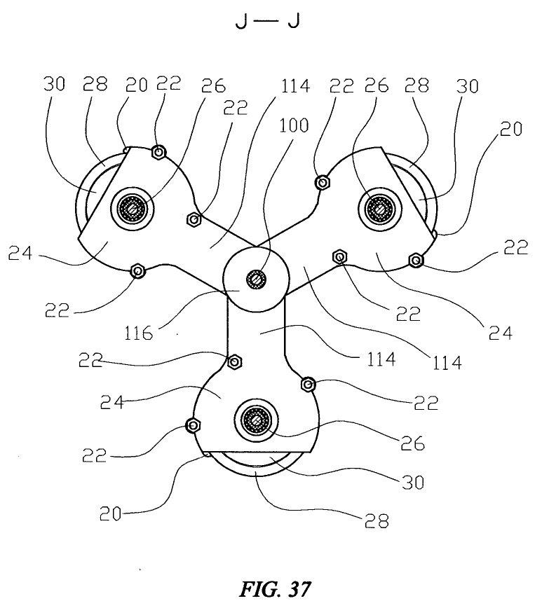

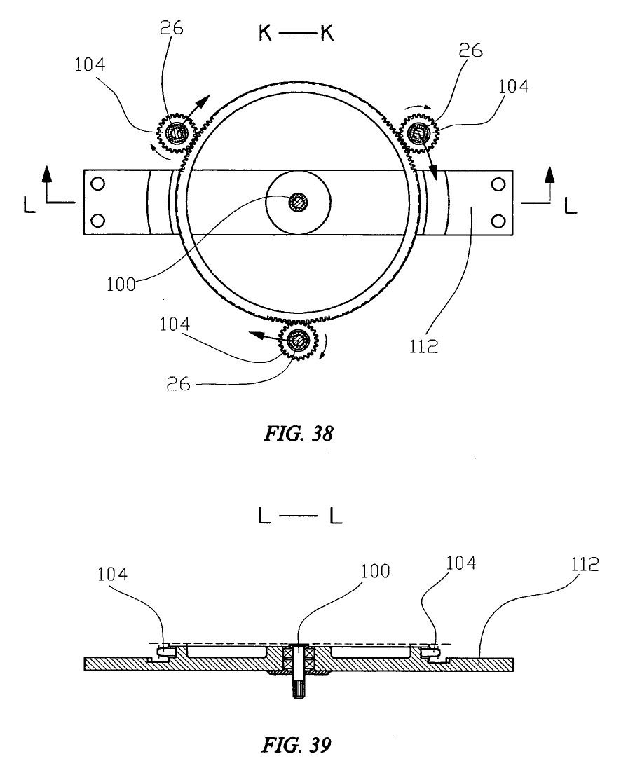

FIG. 35-39 illustrate a cutting device that combines multiple (e.g. three) cutting devices of the present invention to resemble the cutting unit of a reel-type mower. The cutting device utilizes a similar epicyclic gear system to the one shown in FIG. 32-34. Mounting beam 112 provides the grounding for the external central gear 102 as well as a support for the whole cutting device. The planet-carrier is composed of the end plate 24 and the swiveling arm 114 that is emanating from the hub 116. The hub 116 is rigidly attached to central driven shaft 100. When driven by an external power source, the central driven shaft 100 will rotate the swiveling arms 114 and the end plates 24 (therefore the cutting unit 10). While the planet gears 104 are cycling around the external central gear 102, it will rotate the driven shaft 26, which then will rotate the inner blades 16. The relative motion between the inner blades 16 and the outer blades 18 will create efficient cutting actions. There is no need for any bed-knives for direct cutting as used in conventional reel-type mowers.

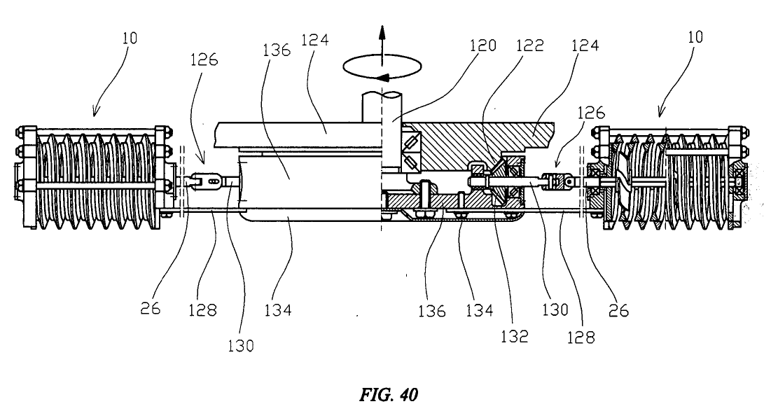

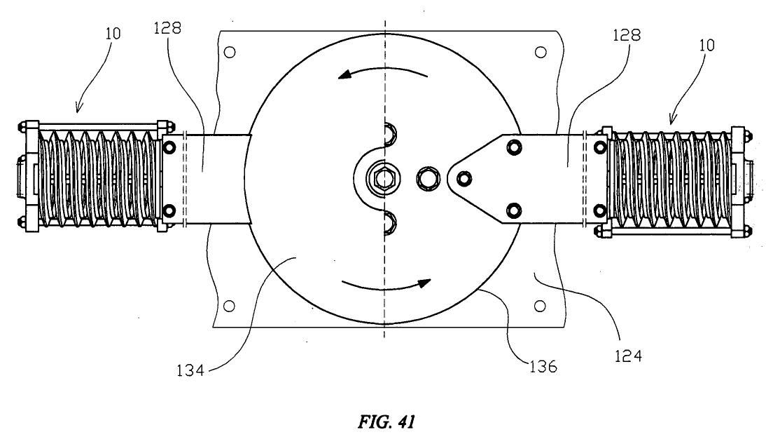

FIG. 40 and FIG. 41 illustrate a cutting device that can be used as the cutting unit for a rotary blade mower. A bevel-gear transmission is used as an external power source to two cutting units 10 of the present invention. The bevel-gear transmission is composed of a central bevel gear 122, two planet bevel gears 132, a protective bottom cover 134, and a transmission lower body 136 and an upper body 124. The transmission upper body 124 provides the grounding for the bevel-gear transmission and is usually rigidly attached to the mower deck. Driven by an external power source, the main driven shaft 120 is able to rotate the bevel gears 132, which will in turn rotate the planet driven shaft 130. The universal joint 126 is used to connect the planet driven shaft 130 and the cutting unit driven shaft 26. The support beam 128 provides a stable and rigid connection between the cutting unit 10 and the bevel-gear transmission. The main driven shaft 120 needs not to spin at high rate of speed due to the efficient cutting action created by the cutting units 10 of the present invention.

It will now be appreciated that illustrative embodiments of the invention are disclosed for a device for cutting objects, such as leaves, twigs, grass-like plants, fibers, hairs, and the like. This cutting device includes internally coupled blades. In one illustrative embodiment, one set of blades is in whole spiral shape either static or dynamically formed while the other is optionally in whole or partial spiral shape. Driven by external power sources, the blades are able to move independently of each other as demonstrated in FIG. 32-34. Preferably but not necessarily, the two sets of blades move in opposite directions. Their relative motions, which include but are not limited to rotation, oscillation along the axes, rotational oscillation around the axes, or combinations of these motions, create cutting actions such as shearing, sawing, or a combination of shearing and sawing. As an integrated function, this device can mulch the cuttings generated by its cutting actions.

Based upon the foregoing, it will be appreciated that embodiments of the present invention may have a number of advantages over the prior art. Some of these advantages include the ability to use rotation, oscillation, or rotational oscillation for cutting, i.e., to generate shearing, sawing or the combination of shearing and sawing; the ability to use 360 degree of the both blades to cut objects; and the ability to include a simple mechanism for adjusting the gap between the blades; and incorporation of a mulching function. Still other advantages will now appear to those skilled in the art.

While the terms shearing, cutting and mulching have been used predominantly herein, other terms may also apply such as slicing and sniping, for example. All such terms should therefore be understood as being illustrative and explanatory in nature without undue limitation.

Thus it will be further appreciated that embodiments and applications of the present invention have been described by way of example only. It should be appreciated by those skilled in the art that many modifications and additions may be made thereto without departing from the spirit of the invention or from the scope of the appended claims.

1. Cutting device, comprising:
two sets of internally coupled blades, said blades cooperating in a cutting action by relative motion therebetween, said blades including:
a) a set of inner blades in at least partial spiral shape, wherein each of said inner blades has at least one cutting edge, and
b) a set of outer blades in at least partial spiral shape, wherein each of said outer blades has at least one cutting edge.

2. Device of claim 1 wherein said cutting actions are selected from the group including shearing, slicing, and sawing.

3. Device of claim 1 wherein said inner blades are spiral, wherein static formations of said inner blades obtain from geometrical properties of a class of shapes including spiral, spring or auger.

4. Device of claim 1 wherein said inner blades have working edges, wherein said blades are spiral and are dynamically formed via rotation and oscillation therebetween at said working edges.

5. Device of claim 4 wherein said working edges form blades or fans.

6. Device of claim 1 wherein said spiral shape of said outer blades is for part or whole spiral/spring shape, comber shape, hybrid shape of comber and spring, or the composite shape of a series of q-shaped units.

7. Device of claim 1 wherein said relative motion is for rotation, oscillation along the axes, rotational oscillation around the axes, or combination of these motions, to create cutting actions such as shearing, sawing, or a combination of shearing and sawing.

8. Device of claim 1 wherein said cutting edges of said blades may be continuous or discontinuous, and may be segmented, smooth, unsmooth and even serrated.

9. Device of claim 1 wherein said cutting blades slippage-stopping mechanisms.

10. Device of claim 1 further comprising a lawn mower, hedge trimmer, hair clipper, cutting or grinding unit, or cutting/mixing unit.

11. Device of claim 1 further comprising means for cutting and/or mulching objects, such as leaves, twigs, grass-like plants, fibers, hairs, and the like.

12. Device of claim 1 wherein said outer blades are part of an outer blade subassembly and may have an end-ring affixed at each end.

13. Device of claim 1 wherein said inner blades is part of an inner blade subassembly and may have an end-disc affixed at each end, wherein each of said end-discs may have a polygon hole in the center.

14. Device of claim 13 wherein said inner blade subassembly may further include one driven shaft, wherein said driven shaft may have a polygon cross-sectional shape for coupling with the polygon hole of said end-discs.

15. Device of claim 13 wherein said inner blade subassembly may further include one or more blowing fans mounted on said driven shaft, said blowing fans may have cutting edges along with their fan-blades for mulching cuttings generated by cutting actions of said inner and outer blades.

16. Device of claim 13, further comprising: a frame subassembly having end-plates wherein said inner blade subassembly and said outer blade subassembly are captured between a first and a second said end-plates, and at least one linking bar for linking said end-plates and stabilizing said device.

17. Device of claim 13 further including at least one mulching blade on at least one of said end-discs of said inner blade subassembly and on said end-plates of said frame subassembly, wherein said mulching blades provide said device with an integrated function of mulching cuttings generated by the cutting actions of said blades.

18. Device of claim 1 further defining a working unit from the group of systems including lawn mowers, hedge trimmers, hair clippers, cutting and grinding units in grinders, or cutting and mixing units in mixers.

19. Method for cutting, mulching and expelling cuttings, including the steps of:
A) providing two sets of internally coupled blades, with at least one set of blades being static or dynamically formed whole spiral shape,
B) enabling the blades to having relative motions therebetween and permitting rotation, oscillation along the axes, rotational oscillation around the axes, or combinations of these motions, to create cutting actions such as shearing, sawing, or a combination of shearing and sawing, with an integrated function of mulching the cuttings generated by the cutting actions,
C) cutting objects thereby, such as leaves, twigs, grass-like plants, fibers, hairs, and the like by action of said sets of blades while mulching the cuttings generated by said cutting action,
D) expelling cuttings via spiral/auger shaped blades cooperating with other means, such as blowing fans and fan units,
E) erecting and raking in objects to be cut by said blades using self-cleaning rotary comber,
F) having slippage-stopping mechanisms built into said blades to prevent objects being cut from escaping the cutting edges of said blades,
G) using bevel-gear transmission to drive said blades to simulate the cutting unit of rotary type mowers.
H) using epicyclic-gear train to drive said blades to simulate the cutting unit of reel type mowers.

20. A cutting device, comprising:
at least two internally coupled blades, of which at least one blade is whole spiral-shaped while the other is at least partial spiral shaped, and the blades having relative rotation therebetween for achieving a cutting action.
